(19) United States
(12) Patent Application Publication
(10) Pub. No.: US 2014/0254938 A1
(43) Pub. Date: Sep. 11, 2014

(54) METHODS AND APPARATUS FOR AN ARTIFACT DETECTION SCHEME BASED ON IMAGE CONTENT

(71) Applicants: Xiaodong Gu, Beijing (CN); Debing Liu, Beijing (CN); Zhibo Chen, Beijing (CN)

(72) Inventors: Xiaodong Gu, Beijing (CN); Debing Liu, Beijing (CN); Zhibo Chen, Beijing (CN)

(73) Assignee: THOMSON LICENSING, Issy de Moulineaux (FR)

(21) Appl. No.: 14/359,926

(22) PCT Filed: Nov. 24, 2011
(86) PCT No.: PCT/CN2011/082873

§ 371 Date: May 22, 2014

(51) Int. Cl. G06T 5/00; G06T 5/20

(52) U.S. Cl. CPC G06T 5/002; G06T 5/20; G06T 2207/20192
USPC 382/199; 382/275

(57) ABSTRACT

Methods and apparatus for artifact detection are provided by the present principles that measure the level of artifacts, such as those caused by temporal concealment of errors due to packet loss, for conditional error concealment. The principles are based on an assumption that sharp edges of video are rarely aligned with macroblock boundaries so video discontinuities are checked throughout the video. The scheme solves the problem of error propagation when temporal concealment of artifacts is used and the high false alarm rates of prior methods. Artifact detection methods are provided for regions of an image, an entire image, or for a video sequence, with error concealment provided conditionally based on the artifact levels.

### FIELD OF THE INVENTION

The present principles relate to methods and apparatus for detecting artifacts in a region of an image, a picture, or a video sequence after a concealment method is proposed.

### BACKGROUND OF THE INVENTION

Compressed video transmitted over unreliable channels such as wireless networks or the Internet may suffer from packet loss. A packet loss leads to image impairment that may cause significant degradation in image quality. In most practical systems, packet loss is detected at the transport layer and decoder error concealment post-processing tries to mitigate the effect of lost packets. This helps to improve image quality but could still leave some noticeable impairments in the video. In some applications such as no-reference video quality evaluation, detection of concealment impairments is typically needed. If only video coding layer information is available (i.e., the bitstream is not provided), concealment artifacts are detected based on image content.

The embodiments described herein provide a scheme for artifact detection. The proposed scheme is also based on the assumption that “sharp edges” are rarely aligned with macroblock boundaries. With an efficient framework, however, the proposed scheme practically solves the problem of error propagation and high false alarm rates.

### SUMMARY OF THE INVENTION

The principles described herein relate to artifact detection. At least one implementation described herein relates to detection of temporal concealment artifacts. The methods and apparatus for artifact detection provided by the principles described herein lower error propagation, particularly in artifacts due to temporal error concealment, and reduce false alarm rates compared to prior approaches.

According to one aspect of the present principles, there is provided a method for artifact detection that produces a value indicative of the level of artifacts present in a region of an image and that is used to conditionally perform error concealment on an image region. The method is comprised of steps for determining an artifact level for an image region based on pixel values in the image, and conditionally performing error concealment in response to the artifact level.

According to another aspect of the present principles, there is provided a method for artifact detection that produces a value indicative of the level of artifacts present in a image and that is used to conditionally perform error concealment on the image. The method is comprised of the aforementioned steps for determining an artifact level for an image region based on pixel values in the image, performed on the regions comprising the entire image. The method is further comprised of steps for removing artifact levels for overlapping regions of the image, for evaluating the ratio of the size of the image covered by regions where artifacts have been detected to the overall size of the entire image, and conditionally performing error concealment in response to the artifact level.

According to another aspect of the present principles, there is provided a method for artifact detection that produces a value indicative of the level of artifacts present in a video sequence and that is used to conditionally perform error concealment on images in the video sequence. The method is comprised of the steps for determining an artifact level for image regions based on pixel values in the image, and performed on the regions comprising the entire images, and on the pictures comprising the video sequence. The method is further comprised of conditionally performing error concealment on images in the video sequence in response to artifact levels.

According to another aspect of the present principles, there is provided an apparatus for artifact detection that produces a value indicative of the level of artifacts present in a region of an image and that is used to conditionally perform error concealment on an image region. The apparatus is comprised of a processor that determines an artifact level for an image region based on pixel values in the image and a concealment module that conditionally performs error concealment on an image region.

According to another aspect of the present principles, there is provided an apparatus for artifact detection that produces a value indicative of the level of artifacts present in an image and that is used to conditionally perform error concealment on an entire image. The apparatus is comprised of the aforementioned processor that determines an artifact level for an image region based on pixel values in the image. The processor operates on the regions comprising the entire image. The apparatus is further comprised of an overlap eraser that removes artifact levels for overlapping regions of the images, a scaling circuit that evaluates the ratio of the size of the picture covered by regions where artifacts have been detected to the overall size of the image, and a concealment module that conditionally performs error concealment on the image.

According to another aspect of the present principles, there is provided an apparatus for artifact detection that produces a value indicative of the level of artifacts present in a video sequence and that is used to conditionally perform error concealment on the video sequence. The apparatus is comprised of the aforementioned processor that determines an artifact level for the images in a video sequence based on pixel values in the images, and that operates on regions comprising the images and on the images comprising the sequence. The apparatus is further comprised of an overlap eraser that removes artifact levels for overlapping regions of the images, a scaling circuit that evaluates the ratio of the size of each image that is covered by regions where artifacts have been detected to the overall size of the images, and a concealment module that conditionally performs error concealment on the images of the video sequence.

These and other aspects, features and advantages of the present principles will become apparent from the following detailed description of exemplary embodiments, which are to be read in connection with the accompanying drawings.

### BRIEF DESCRIPTION OF THE DRAWINGS

FIG. 1 shows the error concealment impairments for (a) spatial concealment and (b) temporal concealment.

FIG. 2 shows the intersample difference at a macroblock boundary: (a) frame with temporal concealment; (b) the hex-value for sample macroblocks.

FIGS. 3 a and b show a limitation of certain traditional solutions: (a) error propagation (b) false alarm.

FIGS. 4 a and b show a sample value for (a) θᵢ(x, y); (b) Φᵢ (x, y).

FIGS. 5 a and b show (a) an exemplary embodiment of the intersample differences taken for an image region and (b) a macroblock and related notations.

FIGS. 6 a and b shows overlapping of two macroblocks when (a) overlap is only vertical and (b) when overlap is vertical and horizontal.

FIG. 7 shows one exemplary embodiment of a method for implementing the principles of the present invention.

FIG. 8 shows another exemplary embodiment of a method for implementing the principles of the present invention on an entire image.

FIG. 9 shows one exemplary embodiment of an apparatus to implement the principles of the present invention.

FIG. 10 shows another exemplary embodiment of an apparatus to implement the principles of the present invention that weights the differences between pixels.

FIG. 11 shows another exemplary embodiment of an apparatus to implement the principles of the present invention that removes the effects of overlapping artifact levels.

### DETAILED DESCRIPTION

The principles described herein relate to artifact detection. Particularly, an object of the principles herein is to produce a value that is indicative of the artifacts present in a region of an image, in a picture, or in a video sequence when packets are lost and error concealment techniques will be used. An example of an artifact, which is commonly found when temporal error concealment is used, is shown in FIG. 1(b).

For temporal error concealment, missing motion vectors are interpolated and damaged video regions are filled in by applying motion compensation. Temporal error concealment typically does not work well when the video sequence contains unsmooth moving objects or in the case of a scene change.

Some traditional temporal concealment detection solutions are based on the assumption that “sharp edges” are rarely aligned with macroblock boundaries in natural images. Based on this assumption, the difference between pixels, both at the horizontal boundary of each macroblock row and inside that macroblock row, are carefully checked to detect temporal concealment. These differences are referred to as intersample differences, which can be differences between adjacent horizontal pixels, adjacent vertical pixels, or between any other specified pixels.

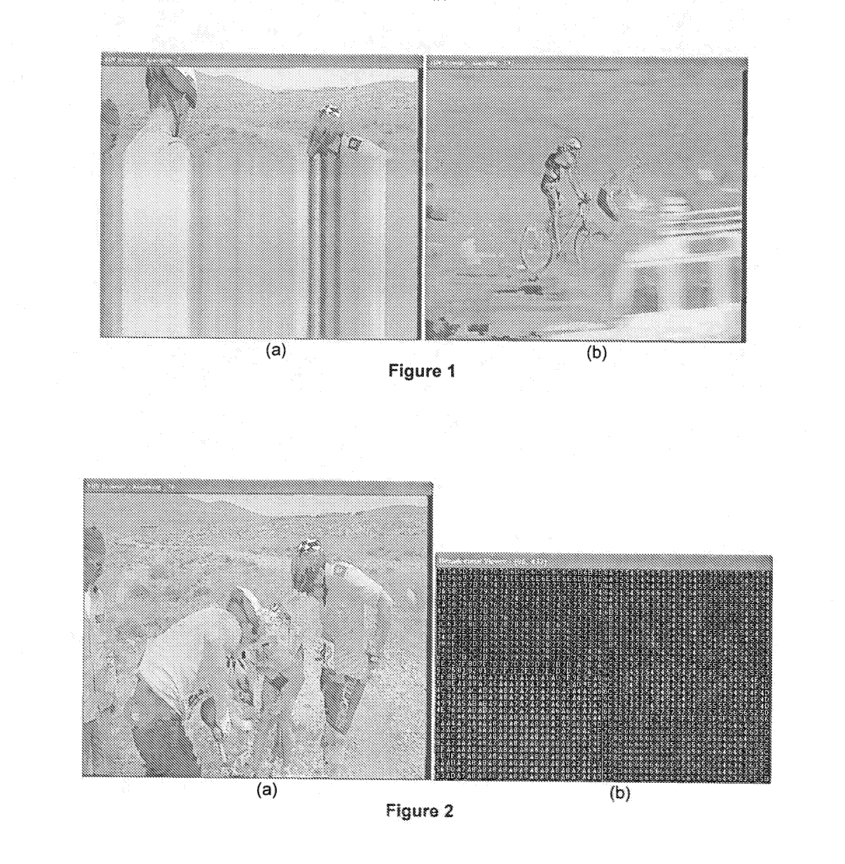

FIG. 2 shows an example of a traditional temporal error concealment artifact. The macroblock in the center of the circle in FIG. 2(a) has a clear discontinuity in macroblock boundary. FIG. 2(b) shows the hex-value of the luminance of four neighboring macroblocks, among which the left-bottom part corresponds to the macroblock in the center of the circle in FIG. 2(a). The lines in FIG. 2(b) identify the macroblock boundaries. The intersample differences at both the horizontal boundary and vertical boundary are much higher than that inside the macroblock.

The performance of some traditional detection solutions is quite limited for several reasons.

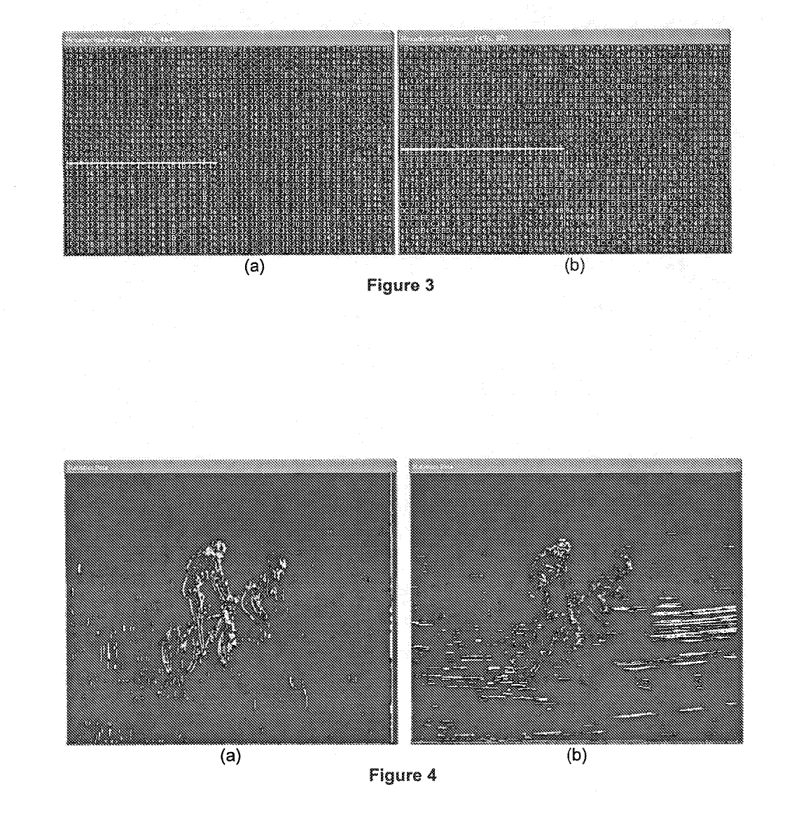

First, many artifacts will be propagated when the current frame is referenced by other frames in video encoding. This is also the case for many temporal concealment artifacts. Because of the error propagation, the content discontinuity will not only happen at macroblock boundaries, but anywhere in the frame. FIG. 3(a) shows the hex value of the luminance of another macroblock from FIG. 2(a), a clear discontinuity can be identified by the line in the first few rows of the lower left macroblock, which is not at the macroblock boundary.

Second, some traditional detection solutions result in high false alarm rates. When there is a natural edge across the macroblock boundary that is not critically aligned with a macroblock boundary, the value of average intersample difference is high as shown in FIG. 3(b). Even though intersample difference at some of the points in the macroblock boundary is low, the scheme falsely determines that an artifact, such as one that occurs for temporal error concealment, is detected.

To solve the problem of high false alarm rates, one embodiment described herein checks the number of discontinuous points in the edge. Discontinuous points are those areas of an image where there is a larger than normal difference between pixels on alternate sides of the edge. If all the pixels in the macroblock boundary are discontinuous points, the image at the macroblock boundary has a higher likelihood of being an artifact. If only some pixels along the macroblock boundary are discontinuous points, and other pixels have a similar average intersample difference, it is more likely that the discontinuous points are caused by some natural edge crossing the macroblock boundary.

To solve the problem of error propagation, one embodiment described herein checks the intersample difference not only at a macroblock boundary, but along all horizontal and vertical lines to determine the level of artifacts present.

According to the analysis just described, the principles described herein propose a scheme for artifact detection to avoid disadvantages of some traditional solutions, that is, error propagation and high false alarm rates. In response to the detection of an artifact level, an error correction technique can conditionally be performed on an image, either instead of, or in addition to, a proposed or already performed error concealment operation.

To illustrate an example of these principles, assume a decoded video sequence V={f₁, f₂, . . . , fₙ} where fᵢ (1≦i≦n) is a frame in a video sequence. The width and height of V is W and H respectively. Suppose the macroblock size is M×M and fᵢ(x, y) is the pixel value at position (x, y) in frame fᵢ.

Intersample Difference

For each frame fᵢ, it is possible to define two two-dimensional (2D) maps θᵢ, Φᵢ: W×H→{0, 1, 2, . . . , 255} by

θᵢ(x,y)=|fᵢ(x,y)−fᵢ(x−1,y)|×mask(x,y)

Φᵢ(x,y)=|fᵢ(x,y)−fᵢ(x,y−1)|×mask(x,y) (1)

For simplicity, let fᵢ(−1,y)=fᵢ(0,y) and fᵢ(x, −1)=fᵢ(x, 0). In the above equations, mask(x, y) is a value, for example between 0 and 1, that indicates a level of masking effect (for example, luminance masking, texture masking, etc.). Detailed information of the masking effect can be found in Y. T. Jia, W. Lin, A. A. Kassim, “Estimating Just-Noticeable Distortion for Video”, in IEEE Transactions on Circuits and Systems for Video Technology, Jul. 2006.

The values of θᵢ(x, y) and Φᵢ(x, y) for the frame in FIG. 1(b) are shown in FIG. 4(a) and FIG. 4(b) respectively. The shown value is simultaneously enlarged for clarification.

A filter g(•), such as one defined by the following equation, is then applied to both of the two maps.

$$g ( x ) = \{ \begin{matrix}g ( x ) & g ( x ) \geq γ \\ 0 & g ( x ) < γ\end{matrix} \qquad ( 2 )$$

where γ is a constant. Another example of a possible filter g(•), is defined by

$$g ( x ) = \{ \begin{matrix}x & x \geq γ \\ 0 & x < γ\end{matrix} \qquad ( 2 )$$

The filtered, or thresholded, versions of θᵢ(x, y) and Φᵢ(x, y) are subsequently also referred to as θᵢ(x, y) and Φᵢ(x, y) in the following description.

Artifacts in a Macroblock

Consider a block whose left-upper corner locates at (x, y). It is desired to determine the level that the block is affected by artifacts, such as temporal error concealment artifacts.

Define θᵢ(x, y) as the number of non-zero values in {θᵢ(x, y),θᵢ(x, y+1), . . . , θᵢ(x, y+M−1)}, and φᵢ(x, y) as the number of non-zero values in {Φᵢ(x, y), Φᵢ(x+1,y), . . . , Φᵢ(x+M−1, y)}. That is, θᵢ(x, y) and φᵢ(x, y) denote the number of non-zero values along the length of a vertical line and a horizontal line started from (x, y) respectively.

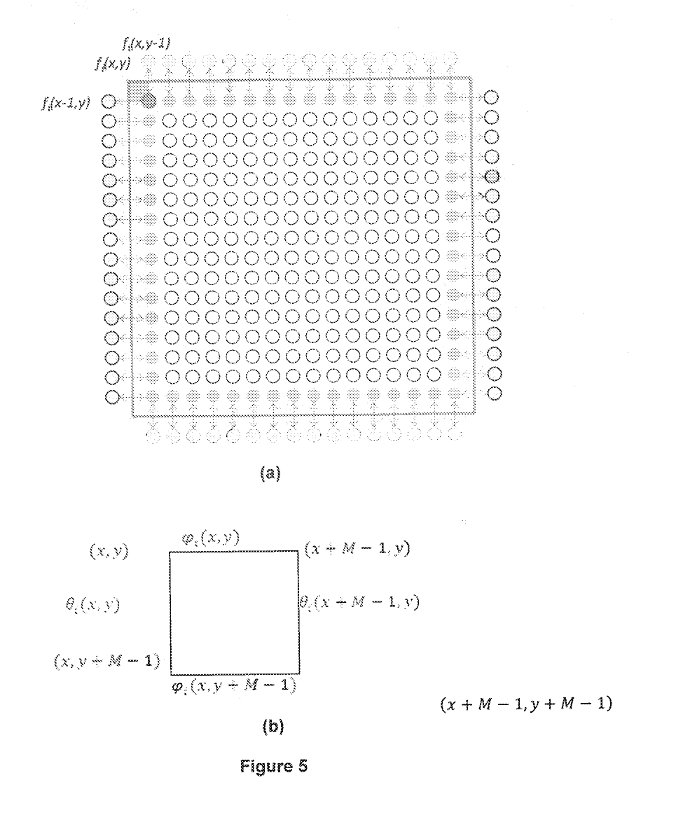

FIG. 5(a) shows intersample differences for one embodiment under the present principles for a region whose left-upper corner locates at (x, y). Differences between the pixels on the edges of the image region and corresponding pixels outside the region, are first found. In this example, the pixels that are outside the region are one pixel position away. Vertical differences are found across the top and bottom of the image, while horizontal differences are found for the left and right sides of the image. Each difference is then subjected to a weight, or mask, as in Equation (1) above. This is followed by filtering, or thresholding, as in Equation (2). The resulting values along each side of the region are then checked to determine how many of the values are above a threshold. If the threshold is taken to be zero, the number of non-zero values for each side, for example, is determined. A rule is then used to find a level of artifacts present in the region, as further described below.

FIG. 5(b) indicates the notations that are used in the analysis. The four corners of the region, for example a macroblock, are located at (x, y), (x, y+M−1), (x+M−1,y), (x+M−1,y+M−1) respectively, where M is the length of the macroblock edge.

The number of non-zero intersample differences at the upper boundary is then identified as φᵢ(x, y), the number of non-zero intersample differences at the bottom boundary is identified as φᵢ(x, y+M−1), the number at the left boundary is identified as θᵢ(x, y), and the number at the right boundary is identified as θᵢ(x+M−1,y).

According to the previous description, higher intersample differences occur frequently at the macroblock boundary, for example, when the macroblock is affected by temporal error concealment artifacts. The rule for determining whether a macroblock is affected by artifacts can be implemented, for example, by a large lookup table, or by a logical combination of the filtered outputs.

One exemplary rule is,

if:

At least two of the four values of φᵢ(x,y),φᵢ(x,y+M−1),θᵢ(x,y) and θᵢ(x+M−1,y) are larger than a threshold c₁; and 1.

The sum of the values of φᵢ(x,y),φᵢ(x,y+M−1),θᵢ(x,y) and θᵢ(x+M−1,y) is larger than a threshold c₂, 2. (3)

then:

the macroblock is deemed to be affected by artifacts.

If the conditions listed in (3) are satisfied, the macroblock is deemed to be affected by artifacts. Otherwise, the macroblock is deemed to not be affected by artifacts. This exemplary rule has particular applicability to temporal error concealment artifact detection, and the logical expression in Equation 3 produces a binary result. However, other rules can be used for determining the level of artifacts in a region of an image that produce an analog value.

Proposed Model for Artifacts Level of a Frame

For an M×M image region, such as a macroblock, whose upper-left corner, for example, locates at (x, y), a method is proposed in the previous paragraphs to evaluate whether that macroblock is affected by artifacts, such as those caused by temporal error concealment, for example. Using this proposed method, it is possible define to what extent a frame fᵢ is affected by artifacts.

STEP 1: Initial Settings for all Image Regions

For every pixel fᵢ(x, y), set the artifact level d(fᵢ, x, y)=1 if the image region whose upper-left corner locates at (x, y) satisfies the conditions in (3); otherwise set d(fᵢ, x, y)=0 if the conditions in (3) are not satisfied.

STEP 2: Erase Overlapping

For two pixels fᵢ(x₁, y₁) and fᵢ(x₂, y₂) satisfying

x₁=x₂,|y₁−y₂|<M

or

y₁=y₂,|x₁−x₂|<M (4)

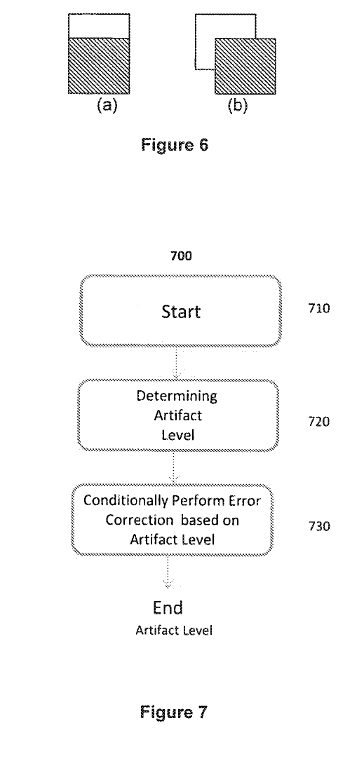

the edges of the corresponding image regions whose upper-left corner is located at these two pixels overlap to some extent. One example of this is shown in FIG. 6(a). In order to decrease the influence of this overlapping, at most one of the image regions can be deemed to be affected by the artifacts.

Decreasing the influence of an overlap can be achieved, for example, by scanning the pixels fᵢ(x₁, y₁) in the frame from left to right and top to bottom, and then, if d(fᵢ, x, y)=1, set d(fᵢ, x+j, y)=d(fᵢ, x, y+j)=0 for every j=1−M, 2−M, . . . , −2, −1, 1, 2, . . . , M−1. This procedure will allow at most one of the image regions to be identified as being affected by artifacts.

STEP 3: Evaluation of Artifacts of Frame

For every pixel in the frame with value d(fᵢ, x, y)=1, there is a corresponding macroblock whose upper-left corner is (x, y). The ratio of the covered pixels by all these macroblocks to the frame size is defined to be the overall evaluation of artifacts of fᵢ, denoted as d(fᵢ).

It should be noted that the above mentioned macroblocks will not have edge overlapping (as shown, for example, in FIG. 6(a)) because of the operations in STEP 2, however there is still space overlapping (as depicted, for example, in FIG. 6(b)). Therefore, the number of non-zero values of d(fᵢ, x, y) times the size of macroblock should not be used to calculate the number of covered pixels by all these macroblocks. If the variable d(fᵢ) is a value that is allowed to range between 0 and 1, a value of d(fᵢ)=0 indicates there are no artifacts at all in the frame while d(fᵢ)=1 indicates the worst case of artifacts in the frame.

STEP 4: Evaluation of Artifacts for a Video Sequence

In order to determine the artifacts evaluation of a video sequence when the artifacts evaluation for every frame or block of the video sequence is known, a pooling problem must be solved. Since pooling strategy is well known in this field of technology, one of ordinary skill in the art can conceive of methods using the present principles to evaluate the level of artifacts in video sequences that is within the scope of these principles.

Parameter Values

In one exemplary embodiment of the present principles, the parameters mentioned in the previous paragraphs are set as follows:

mask(x, y)≡1, for simplicity, so that masking effects are not considered in this particular embodiment;

y=8;

M=16;

c₁=4, c₂=16.

Concealment artifact detection for frames will be easier to determine when bitstream information is provided. However, there are scenarios when the bitstream itself is unavailable. In these situations, concealment artifact detection is based on the image content. The present principles provide such a detection algorithm to detect the artifact level in regions of an image, a frame, or a video sequence.

A presently preferred solution taught in this disclosure is a pixel layer channel artifact detection method, although one skilled in the art can conceive of one or more implementations for a bitstream layer embodiment using the same principles. Although many of the embodiments described relate to artifacts such as those caused by temporal error concealment, it should be understood that the described principles are not limited to temporal error concealment artifacts, and can also relate to detection of artifacts caused by other sources, for example, filtering, channel impairments, or noise.

One embodiment of the present principles is shown in FIG. 7, which is a method for artifact detection, 700. The method starts at step 710 and is further comprised of a step 720 for determining an artifact level for a region of an image. The method is further comprised of a step 730 for conditionally performing error correction based on the artifact level. This error correction can be in addition, or instead of, any error correction operations that may have previously been performed.

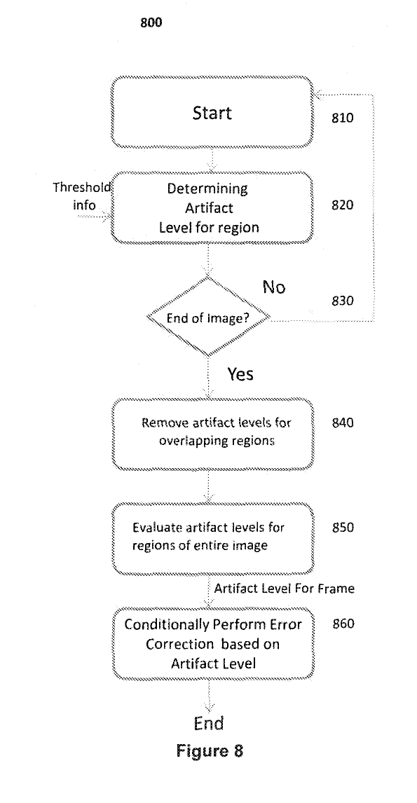

Another embodiment of the present principles is shown in FIG. 8, which comprises a method for artifact detection for a frame of video, 800. The method starts with step 810 and is further comprised of step 820, determining an artifact level for a region of an image. This step can use threshold information that is input from an external source, if not already known. After an artifact level is determined for this region, a decision is made whether the end of the image has been reached. If the end of the image has not been reached, decision circuit 830 sends control back to step 810 to start the process to determine the artifact level for the next region in the image. If decision circuit 830 determines that the end of the image has been reached, removal of artifact levels for overlapping regions occurs in step 840. After this step, an evaluation is performed in step 840 of the artifact levels for the regions of the entire frame, which produces a artifact level for the frame. Following step 850, the method is further comprised of a step 860 for conditionally performing error correction on the entire image based on the artifact level determined in step 850. This error correction can be in addition, or instead of, any error correction operations that may have previously been performed.

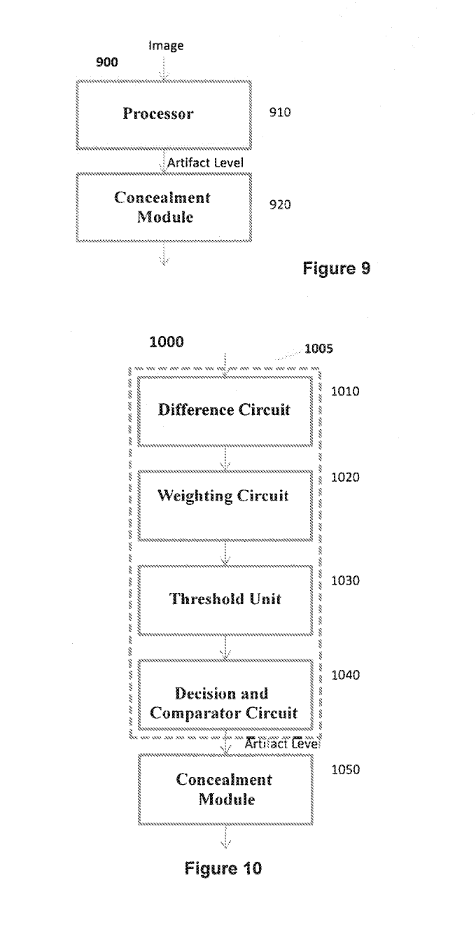

Another embodiment of the present principles is shown in FIG. 9, which shows an apparatus 900 for artifact detection. The apparatus is comprised of a processor 910, that determines an artifact level for a region of an image. The output of processor 910 represents a artifact level for the region of the image, and this output is in signal communication with concealment module 920. Concealment module 920 implements conditional error concealment, based on the artifact level received from processor 910, for the region of the image.

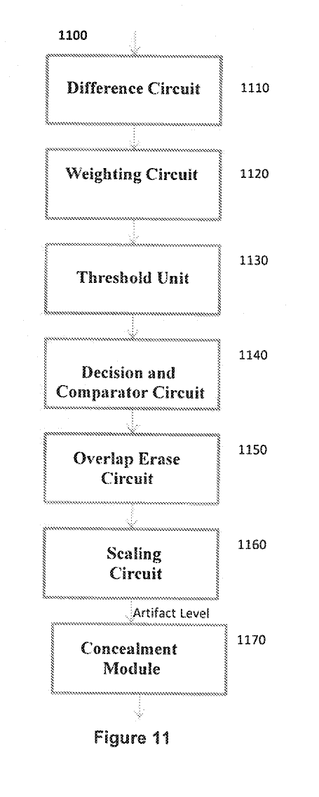

FIG. 10 illustrates another embodiment of the present principles, which is an apparatus for artifact detection, 1000. The apparatus is comprised of a processor 1005. Processor 1005 is comprised of a difference circuit 1010 that finds differences between pixels of an image region. The output of difference circuit 1010 is in signal communication with the input of weighting circuit 1020, that further comprises processor 1005. Weighting circuit 1020 applies weights to the differences found by difference circuit 1010. The output of weighting circuit 1020 is in signal communication with the input of threshold unit 1030, further comprising processor 1005. Threshold unit 1030 can apply threshold operations to the weighted difference values that are output from weighting circuit 1020. The output of threshold unit 1030 is in signal communication with the input of decision and comparator circuit 1040, which further comprises processor 1005. Decision and comparator circuit 1040 determines an artifact level for the image region using, for example, comparisons of threshold unit output values with further threshold values. The output of decision and comparator circuit 1040 is in signal communication with the input of concealment module 1050 that conditionally performs error concealment based on the artifact level from decision and comparator circuit 1040. This error correction can be in addition, or instead of, any error correction operations that may have previously been performed.

Another embodiment of the present principles is shown in FIG. 11, which shows an apparatus 1100 for concealment artifact detection for an image. The apparatus comprises a difference circuit 1110, that finds differences between pixels of an image region, such as a macroblock, for which a determination of an artifact level will be made. The output of difference circuit 1110 is in signal communication with the input to weighting circuit 1120, which takes the differences between pixels of the image region and applies a weight to the differences. The output of weighting circuit 1120 is in signal communication with threshold unit 1130 that applies a threshold, or filtering function to weighted difference values. The output of threshold unit 1130 is in signal communication with the input to decision and comparator circuit 1140. Decision and comparator circuit 1140 determines artifact levels for the image regions of the entire image by, for example, comparing threshold unit 1130 outputs to various further thresholds. The processes performed by difference circuit 1110, weighting circuit 1120, threshold unit 1130, and decision and comparator circuit 1140 is repeated for the regions comprising the picture, until all of the regions of the picture are processed, and the output is sent to the Overlap Eraser Circuit 1150. The output of decision and comparator circuit 1140 is in signal communication with the input to Overlap Eraser Circuit 1150. Overlap Eraser Circuit 1150 determines to what extent the regions whose artifact levels have been determined overlap, and removes the effects of the overlapping to help to avoid an artifact level from being counted twice. The output of Overlap Eraser Circuit 1150 is in signal communication with the input to Scaling Circuit 1160. Scaling Circuit 1160 determines a concealment artifact level for the frame of the image after considering the artifact levels of all regions comprising the frame. This value represents the concealment artifact level for the entire frame. The output of Scaling Circuit 1160 is in signal communication with the input to concealment module 1170, which conditionally performs error concealment based on the artifact level from scaling circuit 1160. This error correction can be in addition, or instead of, any error correction operations that may have previously been performed.

One or more implementations having particular features and aspects of the presently preferred embodiments of the invention have been provided. However, features and aspects of described implementations can also be adapted for other implementations. For example, these implementations and features can be used in the context of other video devices or systems. The implementations and features need not be used in a standard.

Reference in the specification to “one embodiment” or “an embodiment” or “one implementation” or “an implementation” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

The implementations described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or computer software program). An apparatus can be implemented in, for example, appropriate hardware, software, and firmware. The methods can be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein can be embodied in a variety of different equipment or applications. Examples of such equipment include a web server, a laptop, a personal computer, a cell phone, a PDA, and other communication devices. As should be clear, the equipment can be mobile and even installed in a mobile vehicle.

Additionally, the methods can be implemented by instructions being performed by a processor, and such instructions (and/or data values produced by an implementation) can be stored on a processor-readable medium such as, for example, an integrated circuit, a software carrier or other storage device such as, for example, a hard disk, a compact disc, a random access memory (“RAM”), or a read-only memory (“ROM”). The instructions can form an application program tangibly embodied on a processor-readable medium. Instructions can be, for example, in hardware, firmware, software, or a combination. Instructions can be found in, for example, an operating system, a separate application, or a combination of the two. A processor can be characterized, therefore, as, for example, both a device configured to carry out a process and a device that includes a processor-readable medium (such as a storage device) having instructions for carrying out a process. Further, a processor-readable medium can store, in addition to or in lieu of instructions, data values produced by an implementation.

As will be evident to one of skill in the art, implementations can use all or part of the approaches described herein. The implementations can include, for example, instructions for performing a method, or data produced by one of the described embodiments.

A number of implementations have been described. Nevertheless, it will be understood that various modifications can be made. For example, elements of different implementations can be combined, supplemented, modified, or removed to produce other implementations. Additionally, one of ordinary skill will understand that other structures and processes can be substituted for those disclosed and the resulting implementations will perform at least substantially the same function(s), in at least substantially the same way(s), to achieve at least substantially the same result(s) as the implementations disclosed. Accordingly, these and other implementations are contemplated by this disclosure and are within the scope of this disclosure.

1. A method for artifact detection, comprising:
determining an artifact level for a region of an image based on pixel values in the image; and
conditionally performing error correction in response to said artifact level.

2. The method of claim 1, comprising the step of determining said artifact level from differences between values of said pixels of the image region.

3. The method of claim 2, comprising the step of further determining the differences between pixels across edges of the image region.

4. The method of claim 3, comprising the step of weighting the differences.

5. The method of claim 4, comprising the step of determining weighted differences between adjacent ones of the pixels.

6. The method of claim 5, comprising the step of applying a threshold value to said weighted differences for producing threshold results for each said pixel.

7. The method of claim 6, comprising the step of determining said artifact level, at least in part, on how many threshold results exceed the threshold value.

8. The method of claim 7, comprising the steps of:
performing said determining step separately for each said edge of the image region; and,
comparing a number of threshold results that exceed the threshold value for each said edge against a second threshold value.

9. The method of claim 7, comprising the steps of:
performing said determining step for all said edges of the image region; and,
comparing a number of threshold results that exceed the threshold value for all said edges against a second threshold value.

10. The method of claim 7, comprising the step of determining the artifact level based on a combination of:
how many edges of the image region have a number of threshold results exceeding a second threshold value; and,
whether a number of threshold results for all edges of the image region combined exceeds a third threshold value.

11. The method of claim 10, wherein the number of edges having threshold results exceeding a second threshold value must be at least two for the artifact level of the image region to be set to a predetermined value.

12. The method of claim 1, comprising the step of implementing said determining step on image regions of an entire image for producing an artifact level for the entire image.

13. The method of claim 12, further comprising the steps of:
removing artifact levels for pixels of overlapping image regions; and,
evaluating a ratio of size of said image covered by image regions in which artifacts have been detected to overall size of said entire image to produce a measure of artifacts for said entire image.

14. The method of claim 13, comprising the steps of implementing the removing and evaluating steps on frames of a video sequence to produce an artifact level for the video sequence.

15. An apparatus for artifact detection, comprising:
a processor that determines an artifact level for a region of an image based on pixel values in the image; and
a concealment module that conditionally performs error concealment in response to said artifact level.

16. The apparatus of claim 15, said processor further comprising a difference circuit that determines differences between values of said pixels of the image region.

17. The apparatus of claim 16, said difference circuit further finding differences between pixels across edges of the image region.

18. The apparatus of claim 17, said processor further comprising a weighting circuit that applies weights to the differences.

19. The apparatus of claim 18, said difference circuit finding differences between adjacent ones of the pixels.

20. The apparatus of claim 19, said processor further comprising a threshold unit that applies a threshold value to said weighted differences for producing threshold results for each said pixel.

21. The apparatus of claim 20, said processor basing the artifact level, at least in part, on how many threshold results exceed the threshold value.

22. The apparatus of claim 21, said processor comprising:
a decision circuit that separately generates, for each edge of the image region, a number indicative of how many threshold results exceed the threshold value; and,
a comparator that compares said number for each edge of the image region against a second threshold value.

23. The apparatus of claim 21, said processor comprising:
a decision circuit that generates a number indicative of how many threshold results along all edges of the image region exceed the threshold value; and,
a comparator that compares said number against a second threshold value.

24. The apparatus of claim 21, said processor comprising:
a decision circuit that determines the artifact level based on a combination of:
a first number indicative of how many edges of the image region have threshold results exceeding a second threshold value, and
whether a second number, indicative of how many threshold results along all edges of the image region exceed the threshold value, exceeds a third threshold value.

25. The apparatus of claim 24, wherein said decision circuit uses a second threshold value of at least two and sets the artifact level for the image region to a predetermined value when said second number exceeds said third threshold value.

26. The apparatus of claim 15, said processor operating on image regions of an entire image to produce an artifact level for the entire image.

27. An apparatus for artifact detection, comprising:
a processor that determines artifact levels for regions of an entire image based on pixel values in the regions;
an overlap eraser that removes artifact levels for pixels of overlapping regions;
a scaling circuit that evaluates a ratio of size of said entire image that is covered by image regions where artifacts have been detected to entire image size to produce a measure of artifacts for the entire image; and,
a concealment module that conditionally performs error concealment on the entire image in response to said measure.

28. The apparatus of claim 27, said apparatus operating on images of a video sequence to produce a measure of artifacts for the video sequence.
